(19) United States
(12) Patent Application Publication
(10) Pub. No.: US 2025/0312940 A1
(43) Pub. Date: Oct. 9, 2025

(54) MANUFACTURED WOOD PANEL WITH INTEGRATED INORGANIC MATERIAL

(71) Applicant: LOUISIANA-PACIFIC CORPORATION, NASHVILLE, TN (US)

(72) Inventors: CHRISTOPHER DALL, NASHVILLE, TN (US); SCOTT JOHNSON, PORTLAND, OR (US)

(21) Appl. No.: 19/173,646

(22) Filed: Apr. 8, 2025

Related U.S. Application Data
(60) Provisional application No. 63/575,909, filed on Apr. 8, 2024.

(51) Int. Cl. B27N 3/12; B27N 3/00; B27N 3/04

(52) U.S. Cl. CPC B27N 3/12; B27N 3/002; B27N 3/04

(57) ABSTRACT

A manufactured wood panel with integrated fire-resistant (FR) inorganic material, and methods of production. The manufactured wood panel may be structural or non-structural, and strand-based, such as, but not limited to, oriented strand board (OSB). Noncombustible FR inorganic material, including but not limited to, mineral wool, sand, rock, and the like, is added to and mixed with the wood strands before, during, and/or after the blending process on the production line (i.e., mat forming line). The mats formed from the mixed strands and inorganic material are then subjected to heat and pressure in a press. The panel may have multiple strand layers, with all or only some of the strand layers comprising the noncombustible material. The percentage of noncombustible material may be the same in all mixed layers, or may vary between layers.

is application claims benefit of and priority to U.S. Provisional App. No. 63/575,909, filed Apr. 8, 2024, which is incorporated herein in its entirety by specific reference for all purposes.

### FIELD OF INVENTION

This invention relates to a manufactured wood panel with integrated fire-resistant inorganic material. More particularly, this invention relates to strand-based manufactured wood panels with inorganic materials, such as mineral wool, mixed with the strands prior to mat formation.

### BACKGROUND OF THE INVENTION

Building wall, floor and roof assemblies are typically layers of several materials, each performing a single function, that are installed separately on the site or prefabricated offsite in which the building is being constructed. Compatibility between the various layers creates challenges not only for the designer, but also for the installers. Examples of interior and exterior wall assemblies are disclosed in U.S. Pat. No. 4,854,096 (issued Aug. 8, 1989), and U.S. Pat. No. 8,001,736 (issued Aug. 23, 2011), both of which are incorporated herein in their entireties by specific reference for all purposes.

A typical layer in most such assembles is gypsum panels or a wood panel product, or an integral composite engineered panel product, including, but not limited to, engineered wood composite products. Wood-based composites have been found to be acceptable alternatives in most cases to of wood paneling, sheathing and decking lumber. In general, wood-based composites include plywood, particle board, oriented strand board (OSB), wafer board, as well as medium density fiberboard (MDF), with the wood-based composites typically formed from a wood material combined with a thermosetting adhesive to bind the wood substrate together. Often times, the adhesive is combined with other additives to impart additional properties to the wood composites. Additives can include fire retardants, insect repellants, water repellents, preservatives, and color dyes. A significant advantage of wood-based composites is that they have many of the properties of plywood, but can be made from lower grade wood species and waste from other wood product production, and can be formed into panels in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,425,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above-described type are produced with bending, tensile strengths and face strengths comparable to those of commercial softwood plywood.

Building wall, floor and roof assemblies typically are constructed by attaching several panels of the above-described type as to an underlying supporting structure frame as “sheathing.” These sheathing panels are often placed in a pattern forming a substantially continuous flat surface. In certain types of construction, the panels (and other construction materials) may be required under applicable building codes to meet certain fire resistance or water resistance requirements.

For certain applications and/or locations, panels or panel assemblies are required to meet certain fire resistance ratings under applicable codes (i.e., Fire-Rated sheathing). Fire ratings indicates that the panel assembly is built to withstand the heat from a fire for a certain period of time before failing. Typical fire ratings are referred to as one and two hour ratings (or other appropriate time periods). According to the Engineered Wood Association, for example, a one-hour rating indicates that a wall constructed in a manner similar to the one tested will contain flames and high temperatures, and support its full load for at least one hour after the fire begins. Thus, for example, a Fire-Rated OSB sheathing may be used as a component in a 1-hour and/or 2-hour UL-listed (Underwriter Laboratories) fire-rated wall assembly, or in applications where reduced flame propagation performance is required by standards such as ASTM E84 or NFPA 285.

In prior art applications, a fire-retardant-treated (FRT) panel is installed as sheathing at a job or construction site. However, FRT lumber or plywood panels are prone to chemical leaching, and therefore need to be kept dry after installation, and otherwise withstand short-term weather exposure during construction.

Accordingly, what is needed is a wood or wood composite product panel that provides fire resistance and a protective layer to significantly reduce the leaching of fire-retardant during and after construction, without the need for a (water or weather resistant barrier) WRB system applied at the job or construction site.

### SUMMARY OF INVENTION

In various exemplary embodiments, the present invention comprises a manufactured wood panel with integrated fire-resistant (FR) inorganic material. The manufactured wood panel may be structural or non-structural, and strand-based (i.e., manufactured with wood strand technologies), such as, but not limited to, oriented strand board (OSB). Noncombustible FR inorganic material, including but not limited to, mineral wool, sand, rock, and the like, is added to and mixed with the wood strands before, during, and/or after the blending process on the production line (i.e., mat forming line). The mats formed from the mixed strands and inorganic material are then subjected to heat and pressure in a press, with the resultant blanks subject to standard post-press processing to form end-product panels or other manufactured wood products.

In several embodiments, the panel comprises multiple strand layers, with all or only some of the strand layers comprising the noncombustible material. The percentage of noncombustible material may be the same in all mixed layers, or may vary between layers. An optional fines layer and/or optional overlay layer (e.g., paper overlay, or resin-impregnated paper overlay) may be added.

In some embodiments the mixed mineral wool and wood strands are pressed with or between medium density fiberboard (MDF) or high density fiberboard (HDF) (i.e., an engineered wood product generally made by breaking down hardwood or softwood residuals into wood fibre, often in a defibrator, combining it with wax and a resin binder and/or other additives, and forming it into panels by applying high temperature and pressure).

### BRIEF DESCRIPTION OF THE DRAWINGS

FIG. 1 shows a diagram of a method of producing a manufactured wood panel with noncombustible material mixed or blended with the strands in accordance with an exemplary embodiment of the present invention.

FIG. 2 shows a diagram of an alternative method of producing a manufactured wood panel with noncombustible material in accordance with an exemplary embodiment of the present invention.

FIG. 3 shows a diagram of another method of producing a multiple strand layer manufactured wood panel with noncombustible material in all strand layers and optional fines layer and optional overlay in accordance with an exemplary embodiment of the present invention.

FIG. 4 shows a diagram of another method of producing a multiple strand layer manufactured wood panel with noncombustible material in the core strand layer.

FIG. 5 shows a diagram of another method of producing a multiple strand layer manufactured wood panel with noncombustible material in the top and bottom strand layers.

FIG. 6 shows a diagram of another method of producing a multiple strand layer manufactured wood panel with noncombustible material in the top and core strand layers.

FIG. 7 shows a diagram of another method of producing a multiple strand layer manufactured wood panel with noncombustible material in the bottom and core strand layers.

FIG. 8 shows a diagram of another method of producing a multiple strand layer manufactured wood panel with two noncombustible material layers between the strand layers.

FIG. 9 shows a partial cross-section view of a manufactured wood panel with noncombustible material mixed or blended with the strands in accordance with an exemplary embodiment of the present invention.

FIG. 10A shows a partial cross-section view of the manufactured wood panel of FIG. 9 with a medium density fiberboard layer or panel laminated or affixed to one surface.

FIG. 10B shows a partial cross-section view of the manufactured wood panel of FIG. 9 with a medium density fiberboard layer or panel laminated or affixed to both surfaces.

FIG. 11A shows a partial cross-section view of a multiple strand layer manufactured wood panel with noncombustible material in all strand layers.

FIG. 11B shows a partial cross-section view of the multiple strand layer manufactured wood panel of FIG. 11a with an optional fines layer and optional overlay.

FIG. 12A shows a partial cross-section view of a multiple strand layer manufactured wood panel with noncombustible material in the top and bottom strand layers.

FIG. 12B shows a partial cross-section view of a multiple strand layer manufactured wood panel with noncombustible material in the core strand layer.

FIG. 13A shows a partial cross-section view of a multiple strand layer manufactured wood panel with noncombustible material in the top and core strand layers.

FIG. 13B shows a partial cross-section view of the multiple strand layer manufactured wood panel of FIG. 11a with an optional fines layer and optional overlay.

### DETAILED DESCRIPTION OF EXEMPLARY EMBODIMENTS

In various exemplary embodiments, the present invention comprises a manufactured wood panel with integrated fire-resistant (FR) inorganic material. The manufactured wood panel may be structural or non-structural, and strand-based (i.e., manufactured with wood strand technologies), such as, but not limited to, oriented strand board (OSB). Noncombustible FR inorganic material, including but not limited to, mineral wool, sand, rock, mineral wool fibers, ceramic fibers, fly ash, slag, cementitious materials and the like, is added to and mixed with the wood strands during the blending, mixing, and rolling process on the production line. The mats formed from the mixed strands and inorganic material are then subjected to heat and pressure in a press, with the resultant blanks subject to standard post-press processing to form end-product panels or other manufactured wood products.

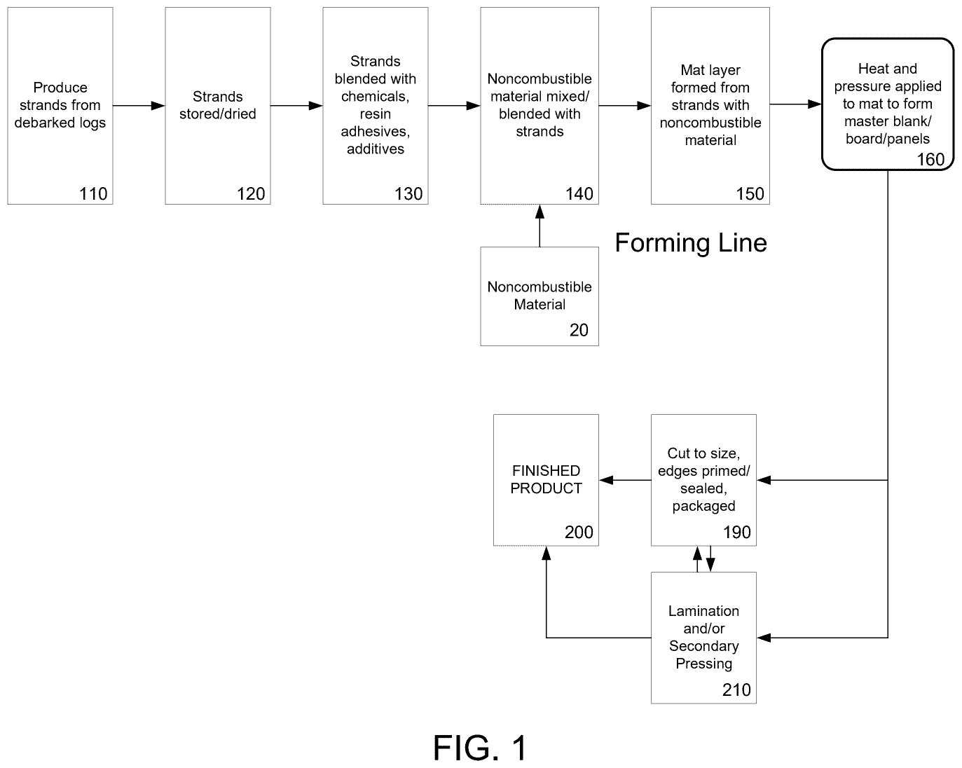

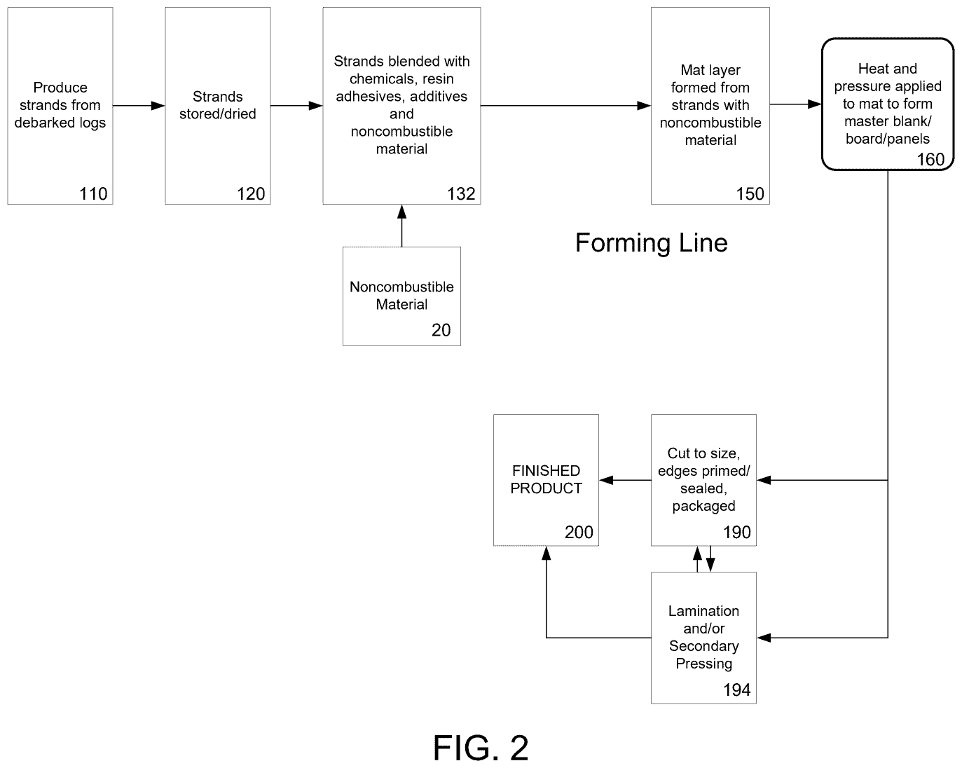

FIG. 1 shows an example of the method of the present invention. Strands are produced from debarked logs 110 and dried and stored 120. The strands are then blended with resins, adhesives, additives, and/or other chemicals 130. Noncombustible FR inorganic material 20 is then mixed with, blended with, or applied to the strands, either before or after 140 the blending 130. In some embodiments, as seen in FIG. 2, the noncombustible FR organic material 20 may be blended with the strands during blending with resins, adhesives and/or other chemicals 132. The strands and noncombustible material mixture are then used to form a mat layer 150 on a forming line.

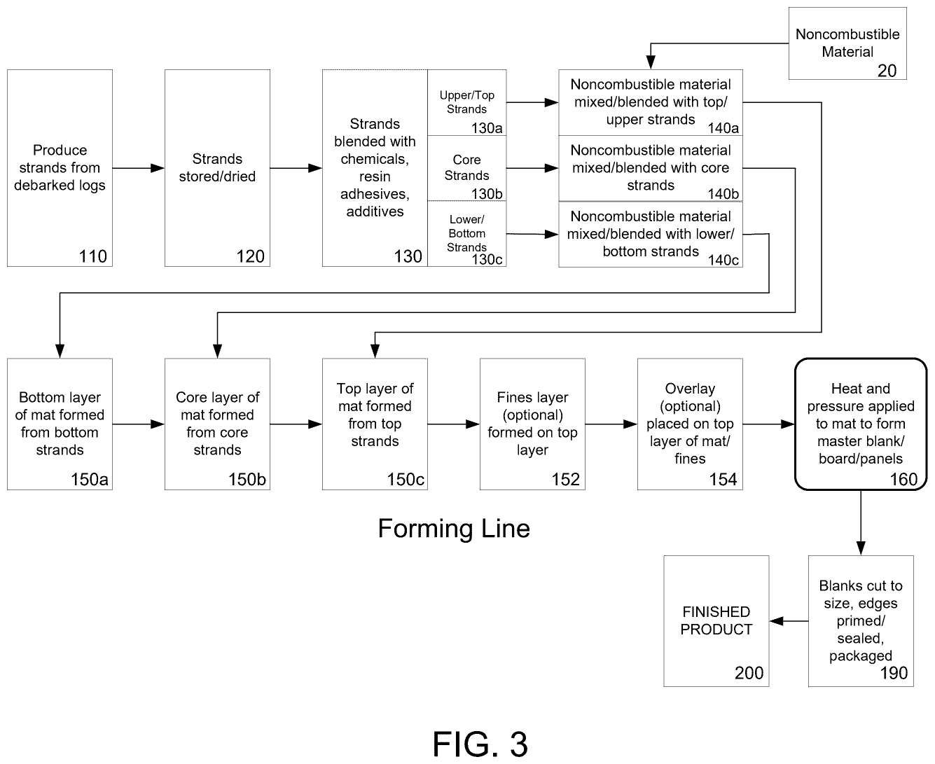

In several embodiments, as seen in FIG. 3, strands are designated for use to form one or more of multiple layers (e.g., bottom layer 140c, core layer 140b, top layer 140a) on a forming line. Strands used to form multiple layers may be treated together, or may be treated separately 130a, 130b, 130c, so that strands in different layers may comprise different types and/or amounts or concentrations of FR material. As described above, the noncombustible material may be mixed with the strands before or after the blending with resins, adhesives, chemicals or additives, or may be included in the blending.

An optional fines layer 152 may be added to the upper surface of the strand mat, as is known in the prior art. The fines layer may not have any FR treatment, although it some embodiments, as seen in FIG. 2, FR material may be mixed with or applied to the wood particles or material making up the fines layer 152. An optional overlay or layer 154 also may be added on top of the mat, with or without any fines layer.

The mat then enters the press and subjected to heat and pressure to form master panels, boards or “blanks” 160. After removal from the press, the master blanks/board/panels are then trimmed or cut to the desired size(s) (e.g., a master can be trimmed, cut or divided in multiple panels or boards of typical sizes sold in the marketplace, such as 4′×8′ panels), with surfaces and/or edges primed and/or sealed, and packaged 190 to produce the finished product 200. In some embodiments, the blanks, boards or panels, before or after being cut to size, may be subject to lamination or secondary pressing 210 with other overlays, panels, or boards, such as MDF or HDF panels or boards. The mixed noncombustible material and wood strands are combined with, or pressed with or between, one or more medium density fiberboard (MDF) or high density fiberboard (HDF) panels. MDF and HDF are engineered wood products generally made by breaking down hardwood or softwood residuals into wood fiber, often in a defibrator, combining it with wax and a resin binder and/or other additives, and forming it into panels by applying high temperature and pressure.

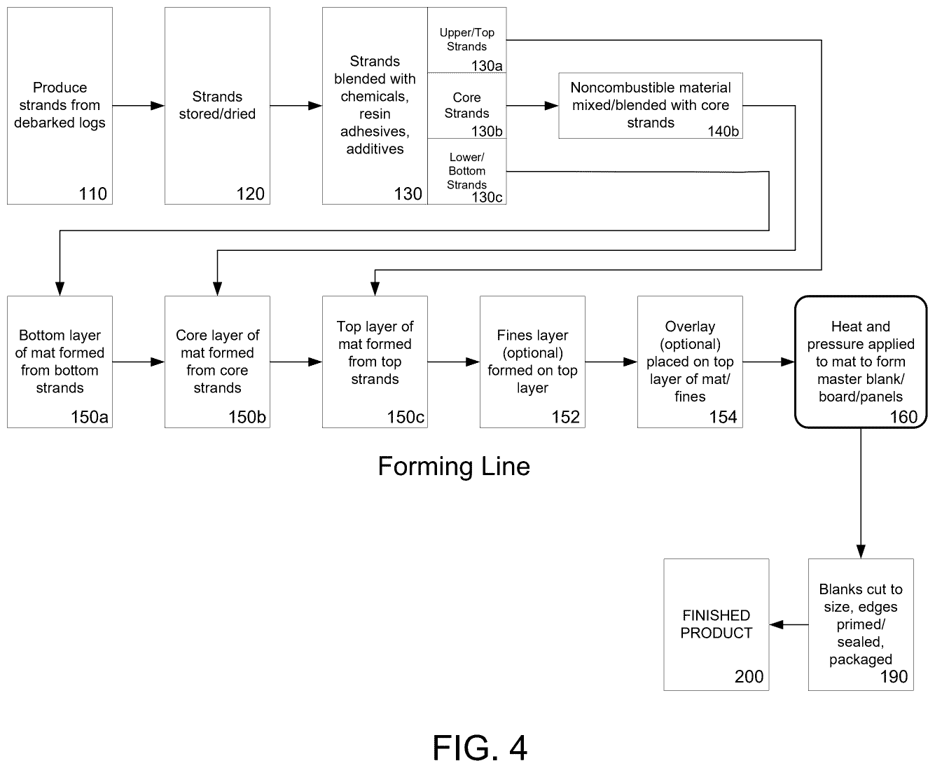

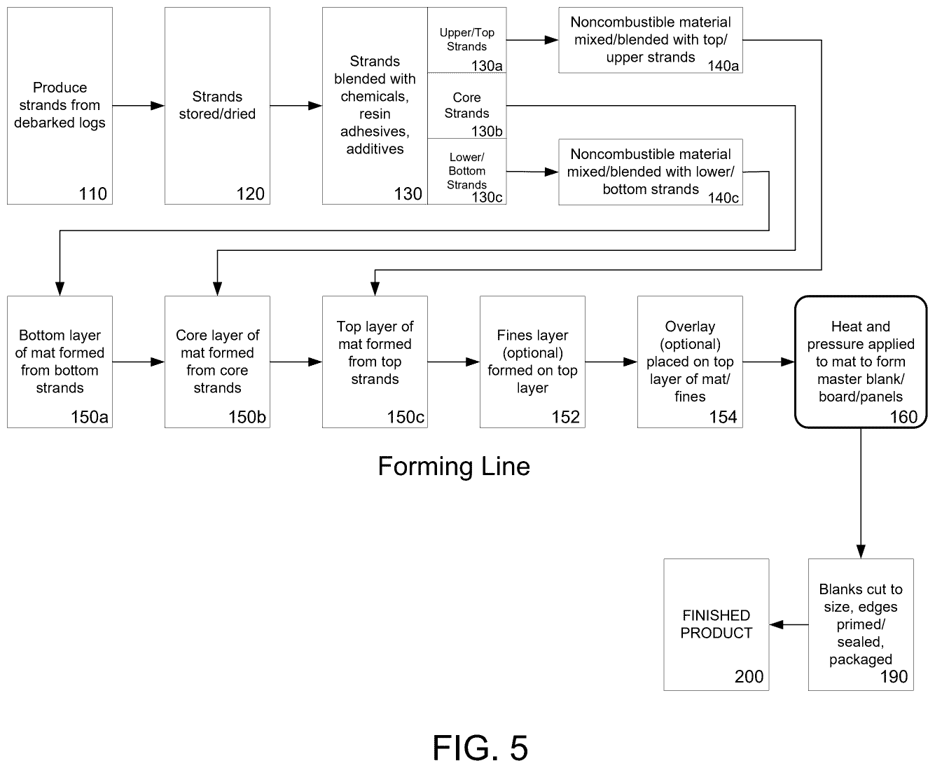

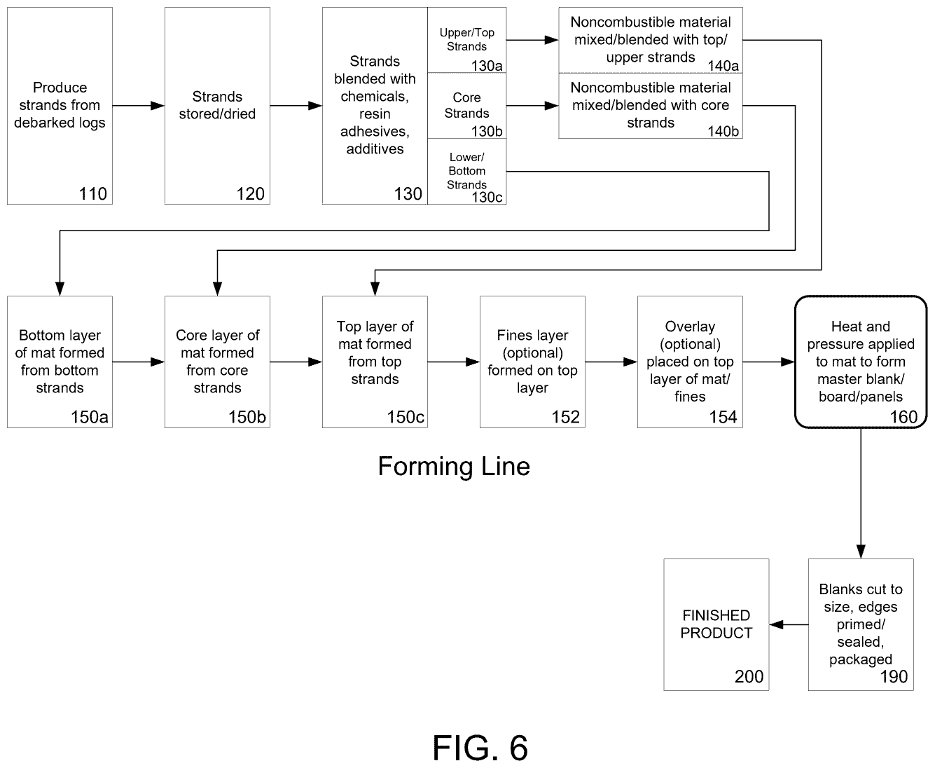

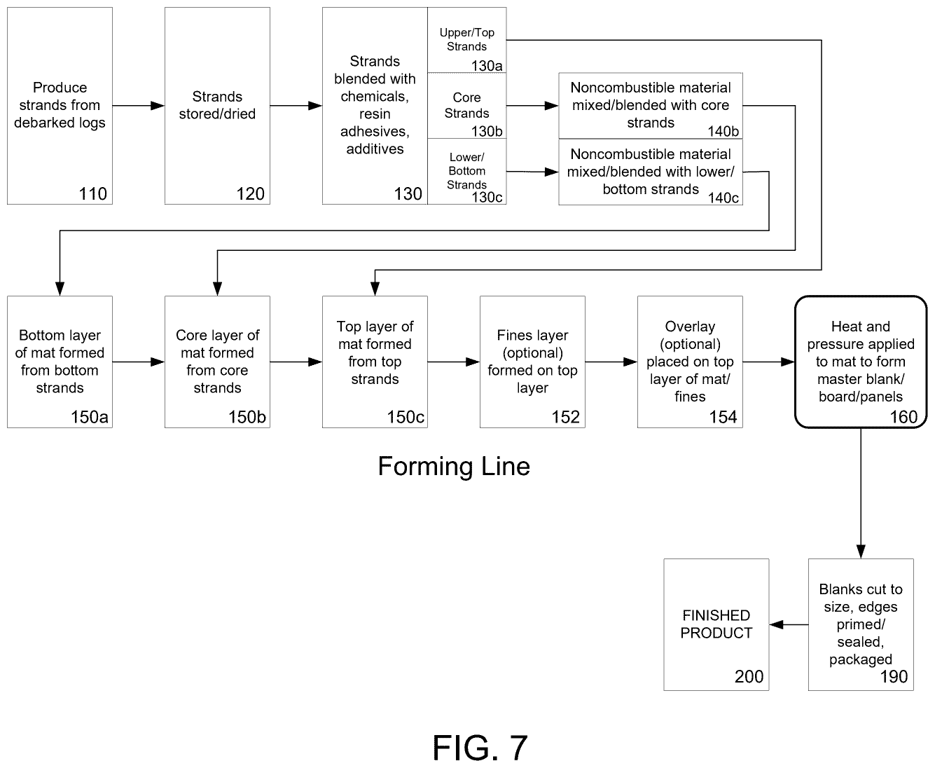

FIG. 3 shows a method for production of a panel with three strand layers, each formed from a set of blended strands, 130a, 130b, 130c, which are then mixed or blended with noncombustible material, 140a, 140b, 140c as described above to form the respective top, core and bottom strand layers 150a, 150b, 150c in the mat. FIG. 4 shows a variation of the method of FIG. 3, where only the core strands are mixed or mixed or blended with noncombustible material 140b. FIG. 5 shows another variation, where only the top and bottom strands are mixed or blended with noncombustible material 140a, 140c. FIG. 6 shows yet another variation, where only the top and core strands are mixed or blended with noncombustible material 140a, 140b. And FIG. 7 shows a further variation, where only the bottom and core strands are mixed or blended with noncombustible material 140c, 140b.

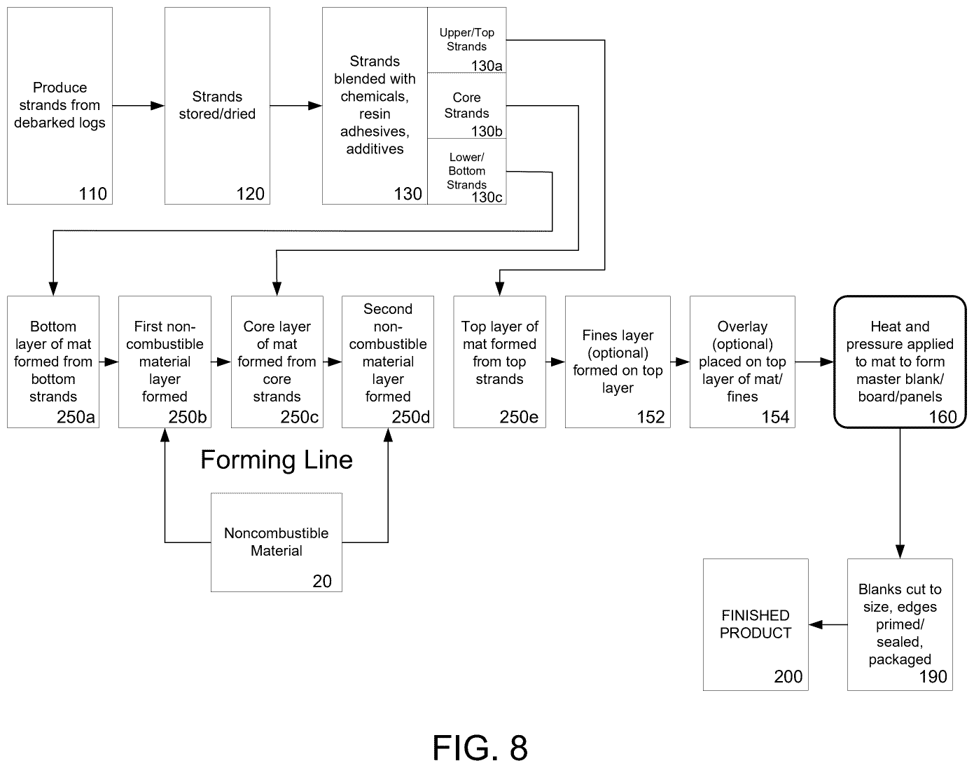

In some embodiments, the noncombustible material is not mixed or blended directly with the strands, but instead is used to form noncombustible material layers within the strand mat. FIG. 8 shows a method for production of a panel with three strand layers 250a, 250c, 250e, and two noncombustible material layers 250b, 250d between the strand layers. Thus, for example, the mat is formed in sequence by forming a bottom strand layer from treated bottom strands, forming a first noncombustible layer on the bottom strand layer, forming a core strand layer from treated core strands on the first noncombustible layer, forming a second noncombustible layer on the core strand layer, and forming a top strand layer from treated top strands on the second noncombustible layer. As described above, an optional fines layer and/or option overlay layer may be added to the mat prior to pressing.

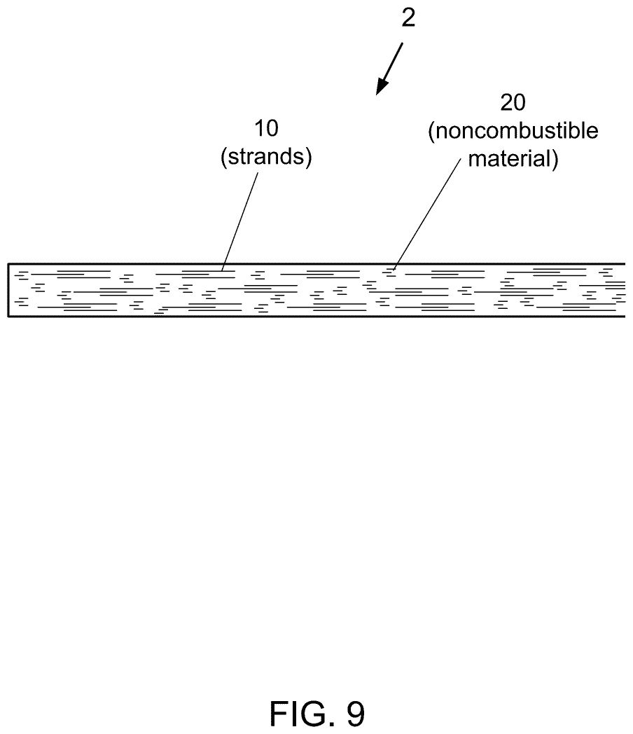

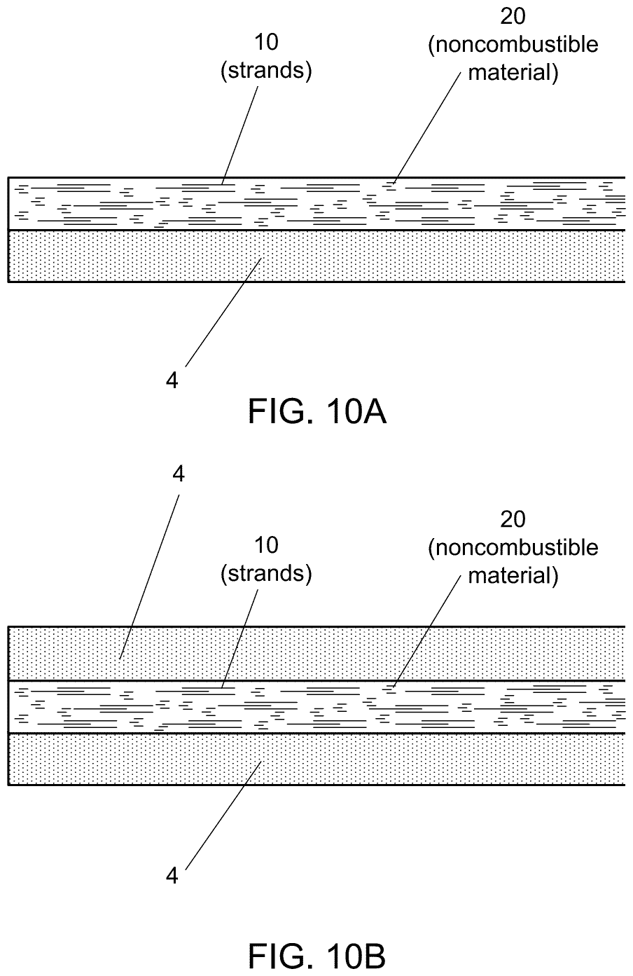

FIGS. 9-13B shows exemplary embodiments of manufactured wood panels 2 with noncombustible material. FIG. 9 shows a panel 2 with a single layer with a mixture of strands 10 and noncombustible material 20. FIGS. 10A-B show an example of the panel of FIG. 9 with one (FIG. 10A) or two (FIG. 10B) MDF or HDF panels 4 affixed (by primary pressing with the strand and noncombustible material mat, or by secondary pressing and/or lamination after the primary pressing of the strand and noncombustible material mat) to one or both surfaces thereof.

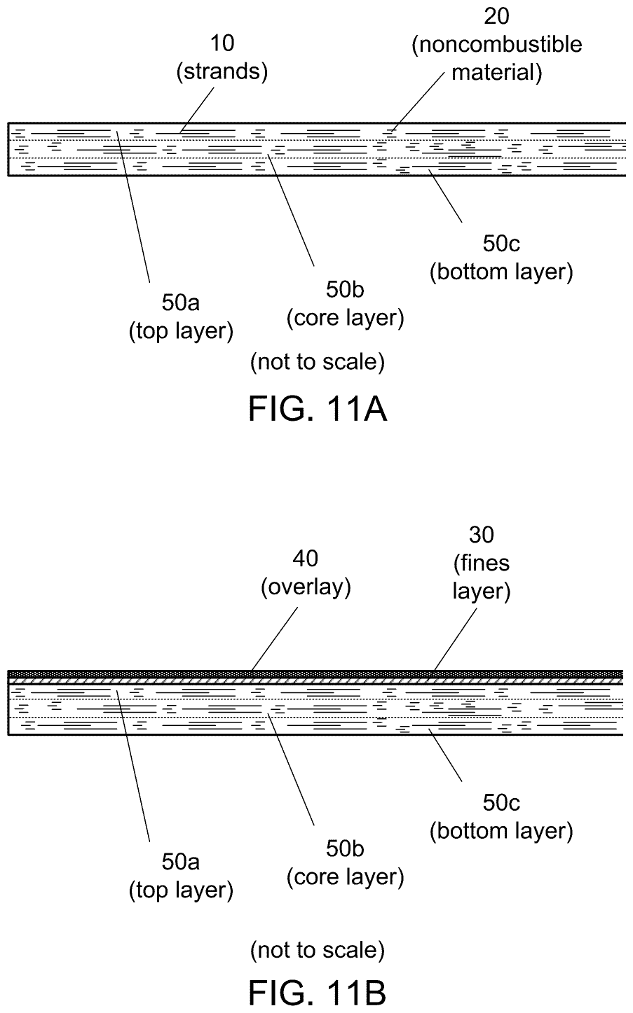

FIG. 11A shows a panel with multiple layers (top 50a, core 50b, and bottom 50c), each layer comprising a mixture of strands and noncombustible material. The relative proportions of strands and noncombustible materials may be the same for each layer, or may differ in one or more layers. Likewise, the specific noncombustible material may be the same for each layer, or may be different in one or more layers. FIG. 11B shows the panel of FIG. 11A with the addition of a fines layer 30 and an overlay 40.

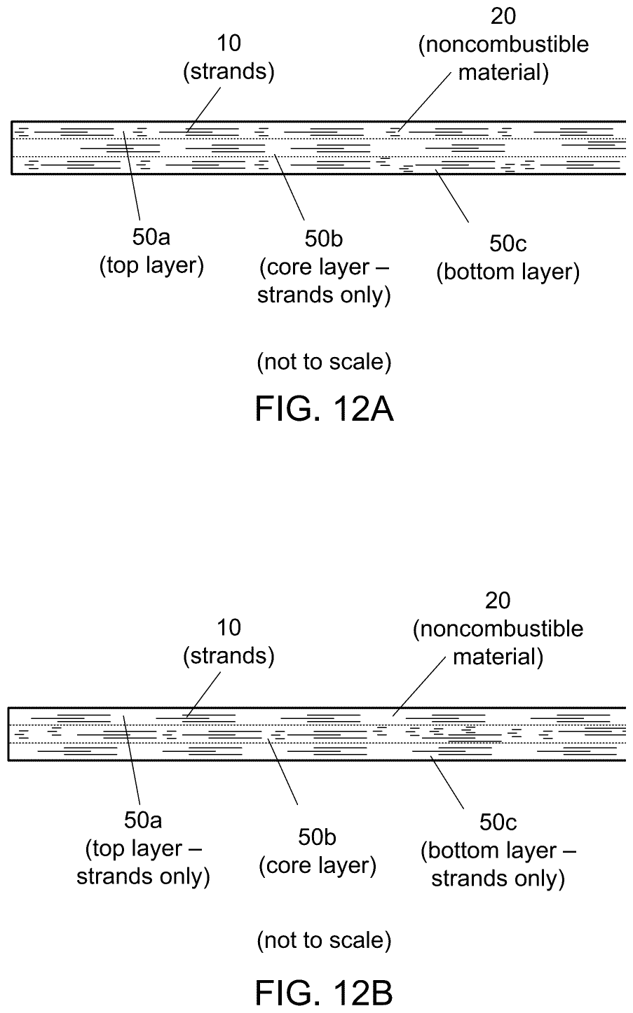

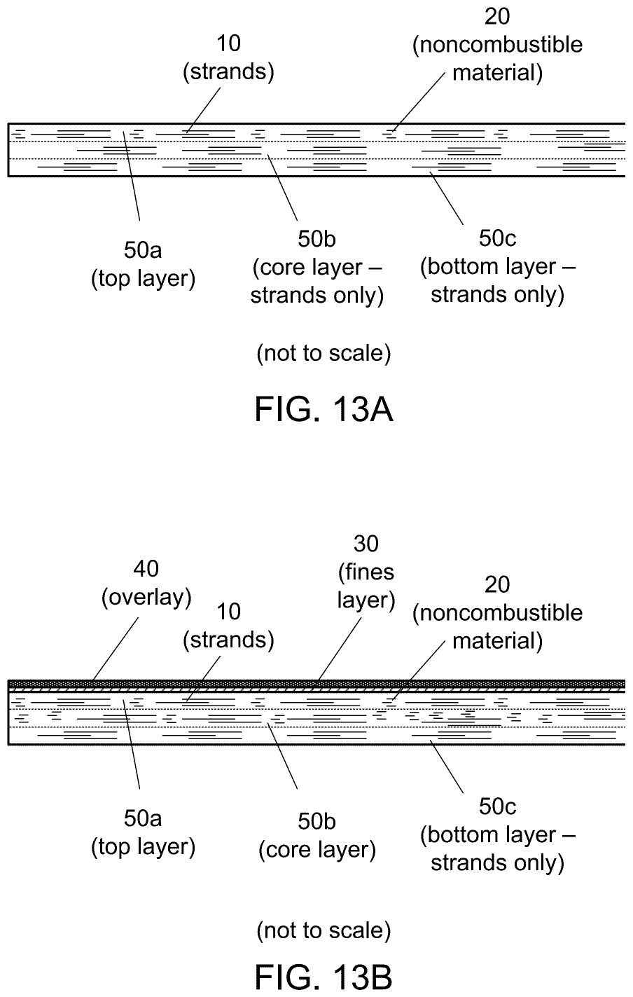

FIG. 12A shows a three-layer panel with noncombustible material only mixed into the core strand layer. FIG. 12B shows a three-layer panel with noncombustible material only mixed into the top and bottom strand layers. FIG. 13A shows a three-layer panel with noncombustible material only mixed into the top strand layer. And FIG. 13B shows a three-layer panel with noncombustible material only mixed into the top and core strand layers, and with the addition of a fines layer 30 and an overlay 40.

In several embodiments, the strand size of the wood portion of the panel is up to approximately 4-inch long (i.e., approximately 4-inches and below), such as the strands commonly used in OSB. The wood strands typically are combined with waxes, resins, adhesives, and/or other additives in a blender prior to mat formation. In accordance with the present invention one or more forms of noncombustible materials, such as mineral wool fibers, ceramic fibers, fly ash, slag, sand, cementitious materials, are blended or mixed with the wood strands, before, during, and/or after the strands are blended with the waxes, resins, adhesives, and/or other additives. In several embodiments, the noncombustible material used may be the byproducts, scraps, and/or remnants of a corresponding noncombustible manufactured product. The noncombustible material may be added at multiple points during the mat-formation process.

In some embodiments, a single-layer core is produced by pressing a single mat layer formed from the mixture of the noncombustible material with the strands and additives to form a single homogenous layer. This single layer may be used independently as a single layer panel, or may be subject to additional processing to add additional layers.

In further embodiments, the panel may comprise multiple layers. In one exemplary embodiment, the panel comprises multiple strand layers, with one or more of the strand layers being mixed with the noncombustible material described above. Thus, for example, the panel may comprise a core layer with a mixture of strands and noncombustible material, with the core layer disposed between a lower strand layer and an upper strand layer. The lower strand layer and upper strand layer may be strand layers without noncombustible material, or one or both may contain noncombustible material (in which case, the core layer may or may not contain noncombustible material).

In embodiments where multiple strand layers comprise noncombustible material the proportions of the components in each layer may be the same, or there may be different proportions among one or more of the layers. For example, the core layer may have a higher proportion of noncombustible material, and thus a higher fire-resistance, than either the lower or upper strand layers. Alternatively, the core layer may have a lower proportion of noncombustible material than either the lower or upper strand layers, or a proportion between the proportions in the other layers. One or more of the layers may be formed so that the noncombustible material is distributed with and/or in the waxes, resins, and adhesives, effectively providing fire resistance around each strand in the layer.

In an alternative embodiment, the panel may be formed by producing a mat with multiple layers of strands with waxes, resins and adhesives and one or more layers of noncombustible material between one or more of the strand layers, and the pressing the mat together under heat and pressure to create the multilayer panel. For example, the panel could have three layers of strands (lower, core, upper) with two noncombustible material layers between the lower and core layers and the upper and core layers, as described above. The noncombustible material in those layers may be the same material or different material, and the thickness of the layers may be the same or may be different.

In a mixed layer, the noncombustible material may range from approximately 15% to approximately 90% by weight or by volume, while the OSB strands and related components would constitute the remaining approximately 85% to approximately 10%. Preferably, the noncombustible material would range from approximately 25% to 35% by weight or by volume.

The panels have fire-resistance performance by having sufficient noncombustible inorganic material(s) added to offset the combustibility characteristics of the wood strands. This fire-resistance (FR) is not due to chemical treatments, overlays, or coatings, although such treatments may be added to the strand layers or the panel itself. The panels may be used on unrated or rated FR rated walls or assemblies where ignition resistance or FR-treated wood is allowed by code or otherwise. In several embodiments, the panels have FR performance sufficient to meet the requirements of the applicable Extended ASTM E84 standard or the NFPA 285 standard. The resulting panels are an alternative to exterior gypsum panels or board for all types of construction.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of producing a manufactured wood panel, comprising the steps of:
blending a plurality of wood strands with one or more chemicals, resins, or adhesives;
forming a first strand mixture by mixing a first inorganic noncombustible material with least some of said plurality of wood strands;
forming, on a forming line, a strand mat comprising said first strand mixture, said strand mat comprising a top surface; and
in a press, applying heat and pressure to the strand mat to form a master blank, panel or board.

2. The method of claim 1, wherein the step of forming a strand mixture is performed after the step of blending.

3. The method of claim 1, wherein the strand mat is a multi-layer strand mat.

4. The method of claim 1, wherein the strand mat has three strand layers.

5. The method of claim 1, wherein the step of forming a strand mat comprises the steps of:
forming a bottom strand layer on the forming line;
after forming the bottom strand layer, forming a core strand layer;
after forming the core strand layer, forming a top strand layer;
wherein at least one of said bottom strand layer, core strand layer, and top strand layer is formed from the first strand mixture.

6. The method of claim 5, wherein the top strand layer and core strand layer are formed from the first strand mixture.

7. The method of claim 5, wherein the top strand layer and core strand layer are formed from the first strand mixture.

8. The method of claim 5, wherein the top strand layer and bottom strand layer are formed from the first strand mixture.

9. The method of claim 5, wherein the first inorganic noncombustible material comprises mineral wool.

10. The method of claim 5, wherein the first inorganic noncombustible material comprises sand or rock.

11. The method of claim 5, wherein the first inorganic noncombustible material comprises cementitious materials.

12. The method of claim 5, wherein the first inorganic noncombustible material comprises ceramic fibers.

13. The method of claim 5, further comprising the step of
forming a second strand mixture by mixing a second inorganic noncombustible material with least some of said plurality of wood strands;
wherein at least one of said bottom strand layer, core strand layer, and top strand layer is formed from the second strand mixture.

14. A manufactured wood panel formed according to claim 5, wherein the manufactured wood panel comprises at least three strand layers, and at least one of said bottom strand layer, core strand layer, and top strand layer is formed from a strand mixture of wood strands and an inorganic noncombustible material.
